(19) United States
(12) Patent Application Publication
(10) Pub. No.: US 2007/0211465 A1
(43) Pub. Date: Sep. 13, 2007

(54) Illumination Apparatus Including A Plurality Of External Electrode Fluorescent Lamps

(75) Inventor: Joung Yeol Cho, Tongyeung-si (KR)

Correspondence Address: SUGHRUE MION, PLLC, 2100 PENNSYLVANIA AVENUE, N.W., SUITE 800, WASHINGTON, DC, 20037, US

(73) Assignee: Joung Yeol Cho, Kyungsangnam-do (KR)

(21) Appl. No.: 11/572,388

(22) PCT Filed: Jul. 27, 2005
(86) PCT No.: PCT/KR05/02437

§ 371 Date: Jan. 19, 2007

(30) Foreign Application Priority Data
Jul. 29, 2004 (KR) 20-2004-0021647
May 16, 2005 (KR) 10-2005-0040536
Jun. 27, 2005 (KR) 20-2005-0018477

(51) Int. Cl. F21S 4/00

(52) U.S. Cl. 362/252; 362/249

(57) ABSTRACT

Disclosed is an illumination apparatus. The apparatus comprises a plurality of external electrode fluorescent lamp (EEFL) sets, each of the sets consisting of a plurality of EEFLs; at least a pair of support members arranged to be opposite to each other so as to support the EEFL sets and having through-holes therein so as to insert both ends of the EEFL; and electric wires provided to a side of the EEFL and electrically connecting the one EEFL set to another EEFL set.

### TECHNICAL FIELD

The invention relates to an illumination apparatus comprising a plurality of external electrode fluorescent lamps having sufficient luminosity and brightness.

### BACKGROUND ART

In the prior art, luminescent advertising lights have been manufactured using a neon sign lamp. Specifically, the advertising lights using the neon sign lamp embodies a variety of advertisements by manufacturing a plurality of neon sign lamps, connecting them in parallel with each other, attaching a switch to the lamps, installing a micro computer in the switch and then turning on and off the lamps in a pre-determined order.

However, it is required to manufacture the neon sign lamps to correspond to an outward form of the advertising lights having the diverse shapes when using the neon sign lamps. With regard to this, it is very difficult to technically adapt the outward form of the neon sign lamp to each shape of the advertising lights having the diverse shapes designed by an advertisement agent (for example, character or picture having a curve), and its expense is high. In addition, in this case, it is further necessary to connecting the neon sign lamps in parallel with each other and to cover the lamps with a material such as acryl used for the advertising lights. However, when the lamp is covered with the material, the emitted light is not brilliant since the neon sign lamp has a low brightness and thus an effectiveness of advertising is remarkably reduced.

In the mean time, a variety of fluorescent lamps such as external electrode fluorescent lamp (EEFL), LED fluorescent lamp and the like have been recently used as luminescent means substituting the neon sign lamp. In particular, the EEFL has such structure that an electrode is formed to an exterior of a discharge lamp rather than in the discharge lamp, contrary to the neon sign lamp having an electrode in a discharge space. The EEFL performs an alternating-type discharge that charged particles are accumulated on both ends in the discharge lamp and a plasma current alternately flows. Accordingly, since the electrode is prevented from directly interacting with the plasma in the EEFL, the EEFL has a long life. In addition, since the electrode is mounted to the exterior of the discharge lamp, it is easy to manufacture the EEFL. Meanwhile, the LED fluorescent lamp is a fluorescent lamp using a luminescent phenomenon occurring when applying a voltage to a semiconductor. It has such advantages that it is a small size, its lifespan is long and a power is less consumed since it directly converts an electric energy into a light energy.

However, it is difficult to design an outward shape of the EEFL to correspond to a shape of advertising lights, contrary to the neon sign lamp. In addition, although a luminosity of the EEFL is brilliant enough to be used for the advertising lights, it is difficult to make the EEFL large in character. Accordingly, it is required to solve an insufficiency of quantity of light resulting from the limitation of the small EEFL.

### DISCLOSURE OF INVENTION

Technical Problem

Accordingly, the present invention has been made to solve the above problems. An object of the invention is to solve the problems of the manufacturing process of luminescent advertising lights manufactured by arranging straight-type external electrode fluorescent lamps (EEFLs), thereby easily performing an assembling process with regard to a mounting.

Another object of the invention is provide an illumination apparatus capable of exhibiting a sufficient brightness even though an EEFL is covered with a clear covering and embodying a generally large quantity of light even though each quantity of light of the EEFLs is small.

Still another object of the invention is to provide an illumination apparatus capable of easily connecting the EEFLs and maintaining a sufficient space between the fluorescent lamps to prevent electric wires from being shorted and entangled.

Yet still another object of the invention is to provide an illumination apparatus exhibiting an sufficient brightness even though an EEFL is covered with a clear covering wherein various colors are expressed with a single device.

Yet still another object of the invention is to provide an illumination apparatus having diverse shapes such as characters or images having bent parts wherein various colors are expressed with a single device and there is no difference of luminous intensities depending on locations.

Yet still another object of the invention is to provide an illumination apparatus comprising a plurality of external electrode fluorescent lamps capable of preventing electric wires connecting the EEFLs from being entangled and closely adhered to each other, thereby preventing breaking and short of the illumination apparatus.

Technical Solution

In order to achieve the objects, according to a first embodiment of the invention, there is provided an illumination apparatus comprising a plurality of external electrode fluorescent lamps connected with an electric wire into a belt shape. According to an embodiment of the invention, the external electrode is preferably covered with an insulating connector so that an electric shock due to an exposure of the external electrode can be prevented.

According to a second embodiment of the invention, there is provided an illumination apparatus comprising a plurality of external electrode fluorescent lamp sets, each set consisting of a plurality of external electrode fluorescent lamps each of which emits a different color of light; and a plurality of electric wires connecting the external electrode fluorescent lamps to each other, each of which emitting a same color of light. In addition, each of the EEFL sets may preferably consist of three EEFLs emitting red, green and blue lights.

According to a third embodiment of the invention, there is provided an illumination apparatus comprising: a plurality of external electrode fluorescent lamp sets, each set consisting of a plurality of external electrode fluorescent lamps; at least one pair of support members arranged to be opposite to each other so as to respectively support the external electrode fluorescent lamp sets and being formed with through-holes into which both ends of the external electrode fluorescent lamps are inserted; and electric wires formed on a side of the external electrode fluorescent lamp and electrically connecting one set of the external electrode fluorescent lamps to another set of the external electrode fluorescent lamps.

According to a preferred embodiment of the invention, the plurality of external electrode fluorescent lamps constituting each of the external electrode fluorescent lamp sets may be a plurality of external electrode fluorescent lamps emitting different colors of lights, and the external electrode fluorescent lamps connected with each of the electric wires may emit a same color of light. In addition, the external electrode fluorescent lamps constituting each of the external electrode fluorescent lamp sets are preferably three external electrode fluorescent lamps emitting red, green and blue lights, respectively.

In addition, according to a preferred embodiment of the invention, the illumination apparatus of the third embodiment may further comprise a support plate having a rectangular shape formed between the pair of support members. Alternatively, the illumination apparatus may further comprise support plates perpendicularly extending from each lower part of the pair of support members toward the opposite support member and having insert recesses formed therein and an insert rod movably inserted between the insert recesses and regulating a width between the support plates. Additionally, the support member, the support plate and the insert rod are preferably made of a clear material such as silicon.

According to a fourth embodiment of the invention, there is provided an illumination apparatus further comprising a clip for fixing the electric wires in addition to the structure of the third embodiment. According to this embodiment, the clip may be structured to separately fix each of the electric wires or to bind and fix each of the wires into a single bundle.

According to a fifth embodiment of the invention, there is provided an illumination apparatus comprising: a plurality of external electrode fluorescent lamp sets, each set consisting of a plurality of external electrode fluorescent lamps; a pair of support members having a plurality of through-holes formed therein and arranged to be opposite to each other; sockets for inserting the external electrode fluorescent lamps, each of which being formed in each of the through-holes; and electric wires provided to a side of the socket and connecting the one set of external electrode fluorescent lamps to the another set of external electrode fluorescent lamps, wherein each of the through-holes is formed at positions corresponding to each other in each of the support members, wherein one end of the external electrode fluorescent lamp is inserted into the socket formed in the through-hole of the one support member and the other end of the external electrode fluorescent lamp is inserted into the socket formed in the through-hole of the other support member, and wherein the external electrode fluorescent lamps connected with each of the electric wires emit a same color of light.

In the illumination apparatus of the fifth embodiment, the plurality of external electrode fluorescent lamps constituting each of the external electrode fluorescent lamp sets may preferably emit different colors of lights, and the illumination apparatus may further comprise a plurality of electric wires connecting the external electrode fluorescent lamps emitting a same color of light. In addition, each of the external electrode fluorescent lamp sets may preferably consist of three external electrode fluorescent lamps emitting red, green and blue lights, respectively.

According to an embodiment of the invention, the illumination apparatus of the fifth embodiment may further comprise a support plate having a rectangular shape and provided between the pair of support members. Alternatively, the illumination apparatus may further comprise support plates perpendicularly extending from each lower part of the pair of support members toward the opposite support member and having insert recesses formed therein and an insert rod movably inserted between the insert recesses and regulating a width between the support plates. Additionally, the support member, the support plate and the insert rod are preferably made of a clear material such as silicon.

Additionally, the illumination apparatus of the fifth embodiment may further comprise a clip for fixing the electric wires wherein the clip may be structured to separately fix each of the electric wires or to bind and fix each of the wires into a single bundle.

Advantageous Effects

According to the invention, since a plurality of external electrode fluorescent lamps express a single character or image, it is possible to easily represent characters or images having diverse shapes, compared to the neon sign lamp expressing a single character or image with a single external electrode fluorescent lamp.

In addition, the illumination apparatus comprising the external electrode fluorescent lamps of the invention has a sufficient brightness even though the exterior of the external electrode fluorescent lamp is covered with a clear covering and can embody a sufficient quantity of light even though quantity of light of each external electrode fluorescent lamp is small.

Additionally, according to the invention, the external electrode fluorescent lamps are easily connected and the space of the fluorescent lamps is maintained to be sufficiently large, so that the short and entanglement of the electric wires can be prevented.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view of a belt-type illumination apparatus wherein a plurality of external electrode fluorescent lamps are arranged in parallel, according to a first embodiment of the invention;

FIG. 2 is an exploded perspective view of a fluorescent lamp connector region shown in FIG. 1;

FIG. 3 is a perspective view of a belt-type illumination apparatus wherein a plurality of external electrode fluorescent lamps are arranged in parallel, according to another embodiment of the invention;

FIG. 4 is a plan view of FIG. 3;

FIG. 5 is a perspective view showing an internal structure of an illumination apparatus comprising a plurality of external electrode fluorescent lamps according to a second embodiment of the invention;

FIG. 6 is a perspective view showing an internal structure of an illumination apparatus comprising a plurality of external electrode fluorescent lamps according to a third embodiment of the invention;

FIG. 7 is a perspective view showing a structure of support members and a support plate according to a third embodiment of the invention;

FIG. 8 is a perspective view showing a state that the internal structure of the illumination apparatus according to the third embodiment of the invention is covered with a sheath;

FIG. 9 is a perspective view showing an internal structure of an illumination apparatus comprising a plurality of external electrode fluorescent lamps according to a fourth embodiment of the invention;

FIG. 10 is a perspective view showing another structure of the illumination apparatus comprising the fluorescent lamps according to the fourth embodiment of the invention;

FIG. 11 is a perspective view showing a structure of an illumination apparatus comprising a plurality of external electrode fluorescent lamps according to a fifth embodiment of the invention;

FIG. 12 is an exploded perspective view showing a structure of support member, a support plate and external electrode fluorescent lamps according to the fifth embodiment of the invention;

FIG. 13 is a perspective view showing an internal structure of an illumination apparatus comprising a plurality of external electrode fluorescent lamps according to a sixth embodiment of the invention;

FIG. 14 is a perspective view showing another structure of the illumination apparatus comprising the fluorescent lamps according to the sixth embodiment of the invention; and

FIG. 15 is a perspective view showing another structure of the illumination apparatus according to the third embodiment of the invention.

### BEST MODE FOR CARRYING OUT THE INVENTION

Hereinafter, preferred embodiments of the present invention will be described with reference to the accompanying drawings. It should be noted that the invention is not limited to the embodiments. In the following description of the present invention, a manufacture process known to those skilled in the art of an external electrode fluorescent lamp, an operation capable of being conventionally performed, and structures and operations of a known apparatus will be omitted.

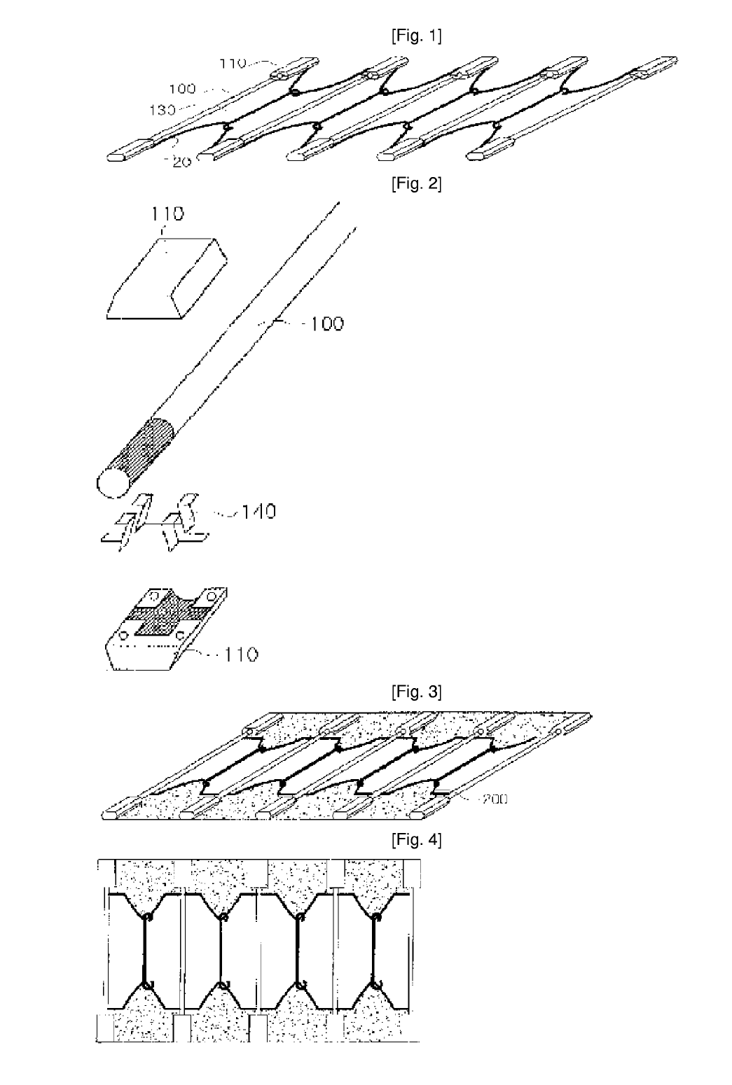

FIG. 1 is a perspective view showing a belt-type illumination apparatus wherein a plurality of external electrode fluorescent lamps (EEFLs) according to a first embodiment of the invention are arranged in parallel. The illumination apparatus comprises a plurality of EEFLs 100, an EEFL connector 110, a electric wire 120, and a connecting link 130. The illumination apparatus can be bent in a plane as well as in a direction perpendicular to the plane. The connecting link 130 is preferably made of an insulating material. FIG. 2 is an exploded perspective view of the EEFL connector 110 region shown in FIG. 1. The connector 110 attached to both ends of the EEFL is made of an insulating material and divided into upper and lower parts. In the connector 110 is mounted an electrode holder 140 to which the EEFL 100 is fitted. To both ends of the electrode holder 140 made of a conductive material is connected the electric wire 120.

FIG. 3 shows an alternative structure of the illumination apparatus according to the first embodiment. In an illumination apparatus shown in FIG. 3, the belt-type EEFLs of the first embodiment shown in FIGS. 1 and 2 are arranged, and both sides of the belt including the EEFL connector 110 and the electric wire 120 are formed with a molded film 200. The molded film 200 is made of resin, silicon and the like and the EEFL connector 110 and the electrode connecting part are formed with an insulating film so as to secure a waterproof ability and an electric stability. FIG. 3 is a perspective view of a belt-type device having both ends of a film shape and FIG. 4 is a plan view of FIG. 3.

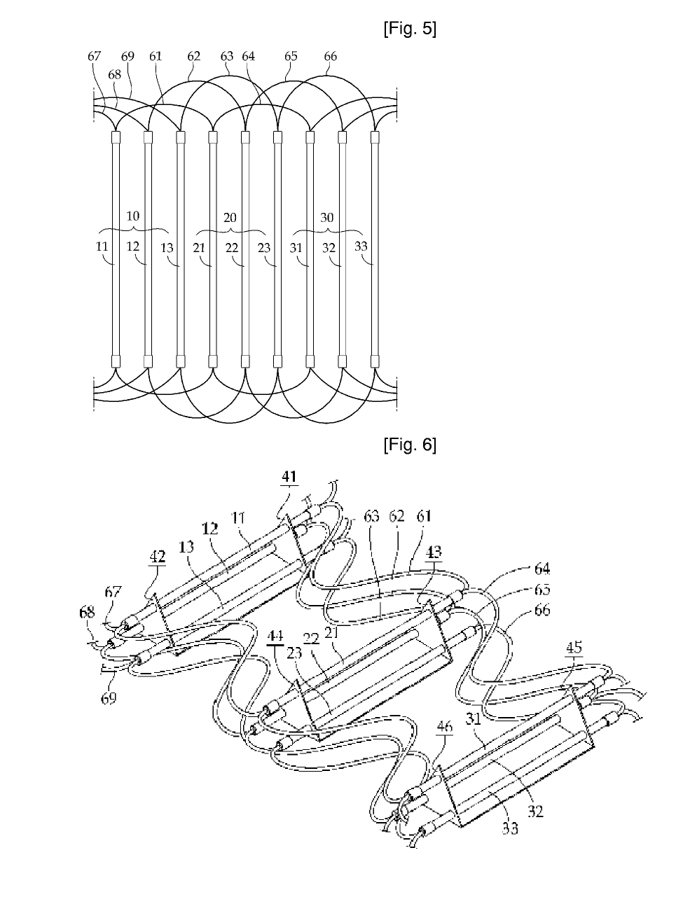

An illumination apparatus according to a second embodiment of the invention is shown in FIG. 5. As shown in FIG. 5, the illumination apparatus according to the second embodiment comprises a plurality of EEFL sets 10, 20, 30, each of the sets consisting of three EEFLs 11, 12, 13; 21, 22, 23; 31, 32, 33. The EEFLs 11, 21, 31 emit a red light, the EEFLs 12, 22, 32 emit a green light and the EEFLs 13, 23, 33 emit a blue light. In addition, electric wires 61, 62, 63; 64, 65, 66 are provided to both ends of each of the EEFLs, wherein the electric wire 61 connects the EEFL 11 and the EEFL 21, the electric wire 62 connects the EEFL 12 and the EEFL 22, and the electric wire 63 connects the EEFL 13 and the EEFL 23. Likewise, the electric wires 63, 54, 65 connect the EEFLs 21, 22, 23 and the EEFLs 31, 32, 33. With such structure, the illumination apparatus of this embodiment can emit red, green and blue lights, respectively. Accordingly, the apparatus can select and emit each of the colors and thus serve as an emitting device having diverse colors as viewed from the outside.

In addition, although it is shown that the EEFLs 11, 12, 13; 21, 22, 23; 31, 32, 33 are arranged to be spaced apart at a regular distance in the same plane, each distance between the EEFLs may be different as necessary.

In the mean time, in the illumination apparatus of the second embodiment, when the wires are different depending on the colors, the electric wires are overlapped, so that the wires are entangled and closely adhered to each other. Accordingly, there can a failure due to the breaking or short. In addition, in the above illumination apparatus, the EEFLs are sequentially arranged, then connected with the electric wires and covered with a proper material depending on characteristics of a product. When one or two EEFLs emit the lights, the residual EEFL is turned off. At this time, since the red-green-blue EEFLs are sequentially arranged, there occurs a difference of luminous intensities between the emitting part (lamp) and the non-emitting part. Therefore, circumferences of the EEFLs not emitting the light are seen to be dark as viewed from the outside of the illumination apparatus. In addition, when the EEFLs are arranged at a narrow distance so as to solve the problem of the difference of the luminous intensities, the problems of the entanglement and close adhesion of the electric wires become worse. Further, when the illumination apparatus is used for the advertising lights, the material covering the EEFL should be embodied into diverse shapes. However, when it is manufactured a extremely bent part, the electric wires cannot be sharply bent. Therefore, there is a limitation in the expression of the diverse shapes.

Hereinafter, an illumination apparatus according to a third embodiment of the invention will be described. FIG. 6 is a perspective view showing an internal structure of an illumination apparatus comprising a plurality of external electrode fluorescent lamps according to a third embodiment of the invention.

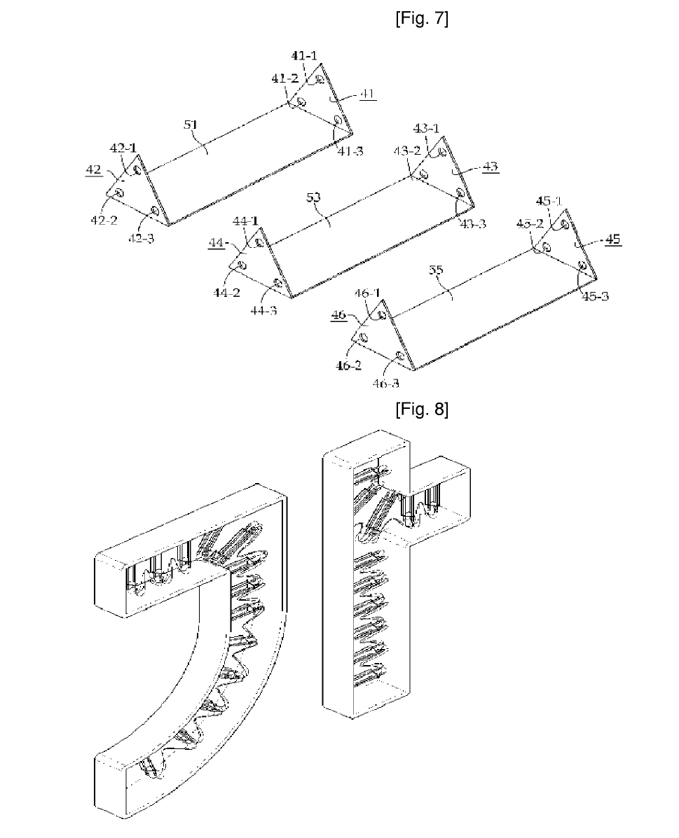

The illumination apparatus according to the third embodiment comprises a first EEFL set consisting of EEFLs 11, 12, 13, a second EEFL set consisting of EEFLs 21, 22, 23 and a third EEFL set consisting of EEFLs 31, 32, 33. FIG. 7 is a perspective view showing a structure of support members 41, 42; 43, 44; 45, 46 and support plates 51, 52, 53 according to an embodiment of the invention. As shown in FIG. 7, three through-holes 41-1, 42-1, 43-1; 44-1, 45-1, 46-1 are respectively formed in each of the support members 41, 42 and the support plate 51 is perpendicularly provided to bottoms of the support members 41, 42, so that the support members 45, 46 are opposite to each other. In the same manner, three through-holes are respectively formed in each of the support members 43, 44; 45, 46 and the support plates 53, 55 are provided between the support members so that the support members are opposite to each other in a longitudinal direction. The support members 41, 42; 43, 44; 45, 46 are preferably to be parallel with each other. According to the third embodiment, the support member is made of a clear material including silicon essentially. The support members are connected to the support plate using an adhesive such as double sided tape.

As can be shown in FIG. 6, an end of the EEFL 11 is inserted into the through hole 41-1 and the other end of the EEFL 11 is inserted into the through-hole 42-1. In addition, both ends of the EEFLs 12, 13 are respectively inserted into the through-holes 41-2, 42-2; 41-3, 42-3, so that all the EEFLs 11, 12, 13 constituting the first EEFL set are inserted into the through-holes of the support members 41, 42. In the same manner, the EEFLs 21, 22, 23; 31, 32, 33 constituting the second and third EEFL sets are respectively inserted into the through-holes 43-1, 44-1; 43-2, 44-2; 43-3, 44-3; 45-1, 46-1; 45-2, 46-2; 45-3, 46-3). Meanwhile, the EEFLs 11, 12, 13 may be fixed in the through-holes using an adhesive or engaging method. That is, the invention is not limited to manners of inserting and fixing the EEFL in the through-holes.

In addition, the EEFLs 11, 12, 13 constituting the first EEFL set and the EEFLs 21, 22, 23 constituting the second EEFL set are connected to each other through the electric wires 61, 62, 63, and the EEFLs 21, 22, 23 constituting the second EEFL set and the EEFLs 31, 32, 33 constituting the third EEFL set are connected to each other through the electric wires 64, 65, 66.

Additionally, as shown in FIG. 6, each of the EEFLs constituting the first set is connected to a power (not shown) through the electric wires 67, 68, 69. A switch having a micro computer mounted therein is attached between the power and the first EEFL set. Based on a program installed in the computer, seven colors, i.e., red, green, blue, red-green, red-blue, green-blue and red-green-blue colors of the EEFLs are sequentially turned on and off, thereby emitting diverse colors of lights. In the mean time, according to this embodiment, the three EEFLs constituting each of the EEFL sets are structured to emit red, green and blue lights, respectively. Each of the EEFLs connected with the same electric wire in the first to third EEFL sets is structured to emit a same color of light. For example, in this embodiment, it is structured such that the EEFLs 11, 21, 31 emit a red light, the EEFLs 12, 22, 32 emit a green light and the EEFLs 13, 23, 33 emit a blue light. However, it should be noted that all the EEFLs may emit a same color of light or different colors of lights.

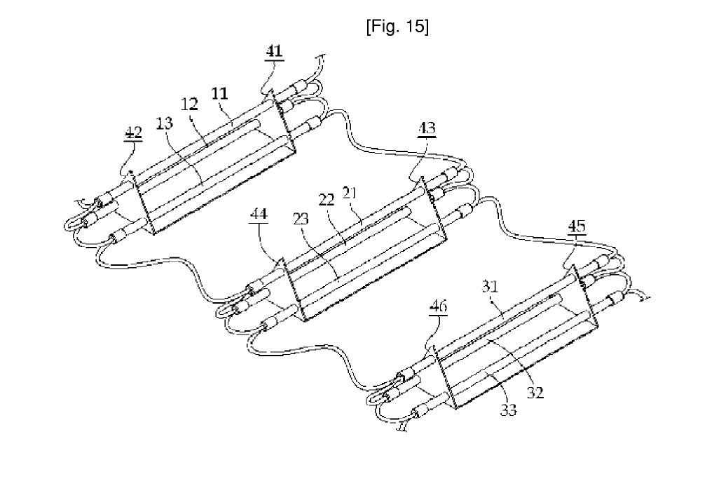

FIG. 15 is a perspective view showing a structure of a modified illumination apparatus of the third embodiment. As shown in FIG. 15, the electric wires are not connected to the EEFLs 11, 12, 13 constituting the first EEFL set, the EEFLs 21, 22, 23 constituting the second EEFL set and the EEFLs 31, 32, 33 constituting the third EEFL set, respectively. Instead, the electric wires are sequentially connected to the EEFL 11, EEFL 12, EEFL 13, EEFL 21, EEFL 22, EEFL 23, EEFL 31, EEFL 32, and EEFL 33.

FIG. 8 is a perspective view showing an outward shape of an illumination apparatus according to a third embodiment of the invention, wherein the EEFLs and the support members are covered with a sheath. As can be seen from in FIG. 8, the illumination apparatus embodies a character having a certain shape. Since the illumination apparatus comprises the small sized EEFLs in the sheath, it is possible to easily form a bent region. Accordingly, the invention is efficient to advertise using the diverse characters and images. In addition, since the EEFLs make a triangle shape in the illumination apparatus, it is possible to use more EEFLs to a signboard having a same size, compared to such structure that the EEFLs are arranged in a plane, and thus to highly increase the quantity of light.

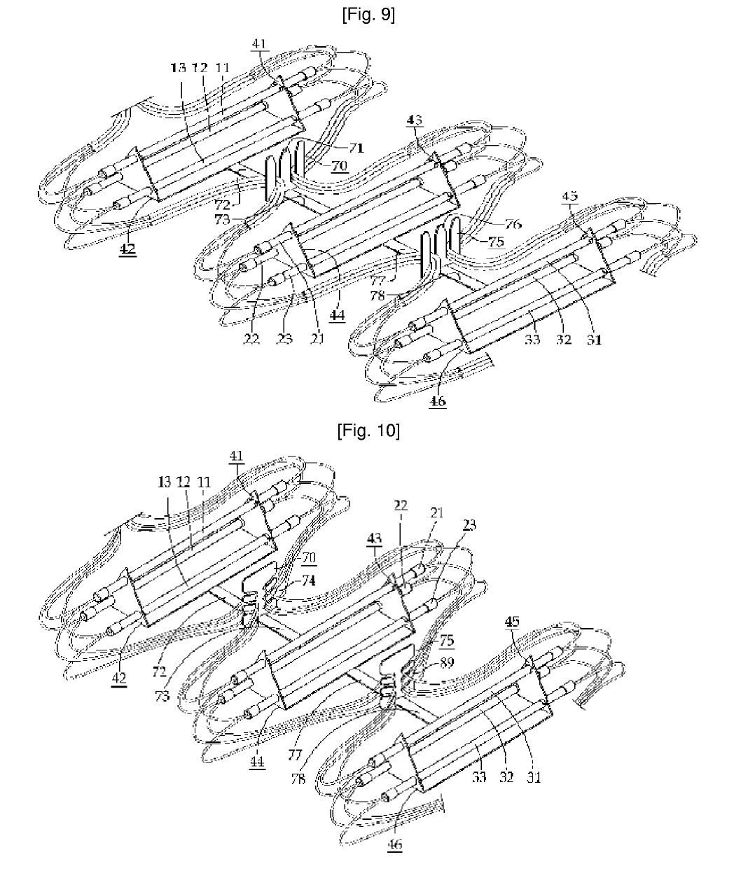

FIG. 9 is a perspective view showing an internal structure of an illumination apparatus comprising a plurality of external electrode fluorescent lamps according to a fourth embodiment of the invention. In FIG. 9, the elements performing the same functions as the embodiment in FIG. 6 are referred to with the same reference numerals as in FIG. 6.

According to the fourth embodiment of the invention, clips 70, 75 for fixing the electric wires 61, 62, 63; 64, 65, 66 connecting each of the EEFLs are provided. The wire fixing clip 70 comprises connecting parts 72, 73 respectively connected to sides of the support plates 51, 52 and a fixing part 71 to which the electric wires are fitted, so as to prevent a shake. Likewise, the wire fixing clip 75 comprises connecting parts 77, 78 respectively connected to sides of the support plates 52, 53 and a fixing part 76 to which the electric wires are fitted, so as to prevent a shake. In addition, the electric wires 61, 62, 63; 64, 65, 66 extending from the EEFLs are respectively coated with an insulating material and then combined into one. After that, the combined wires are fitted and fixed into recesses of the fixing parts 71, 76. Accordingly, it is possible to the breaking or short of the wires due to the movement or collision of the wires, even when the illumination apparatus is moved or shocked. In addition, in order to easily move the support plate and the EEFL set, the connecting parts 72, 73; 77, 78 are preferably made of a high elastic material.

Like this, when the electric wires are fitted and fixed into the recesses of the fixing parts 71, 76 of the clips 70, 75 so that the wires are not moved, the wires are prevented from being moved even when the illumination apparatus is moved or shaken due to the exterior environments. Accordingly, it is possible to previously prevent the difference of luminous intensities due to the electric wires and the breaking or short.

In the mean time, FIG. 10 is a perspective view showing a structure of an illumination apparatus comprising modified clips 70, 75. As shown in FIG. 10, fixing parts 74, 89 of the electric wire fixing clip 70, 75 have a comb shape having recesses corresponding to the number of electric wires extending from the EEFLs. In particular, the fixing parts 74, 89 in FIG. 10 are advantageous in that when a high voltage is used, it is possible to prevent an electromagnetic interference from occurring due to a narrow space between the electric wires.

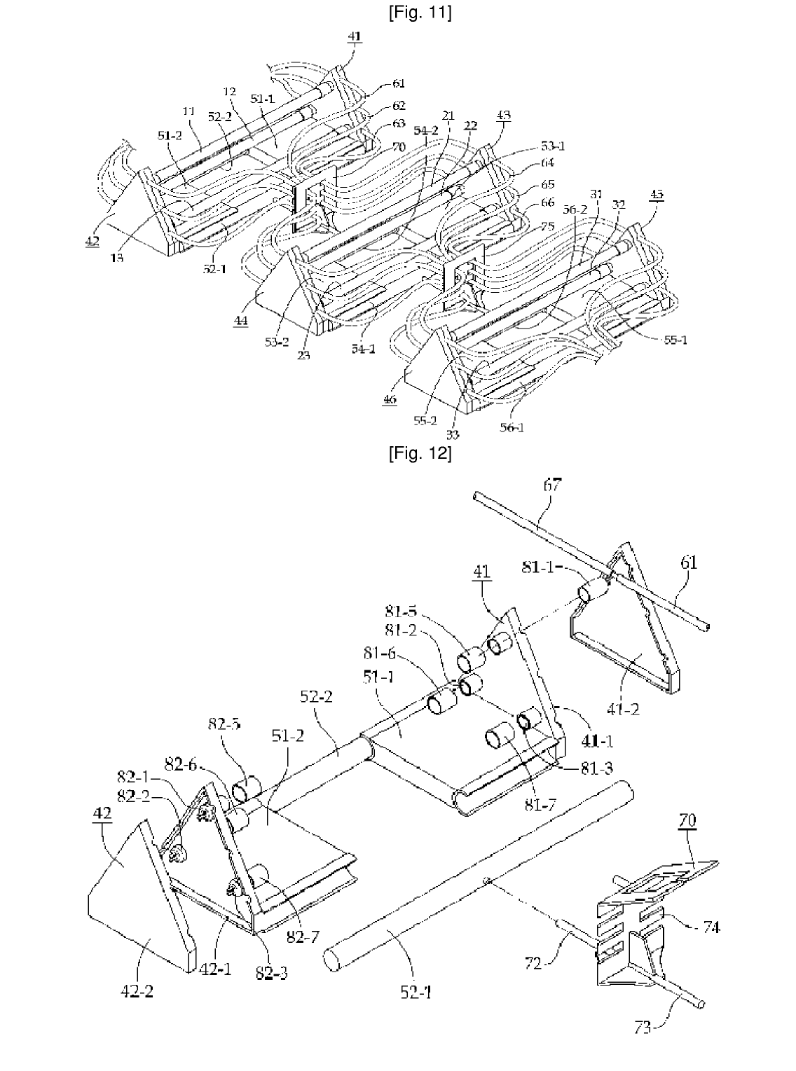

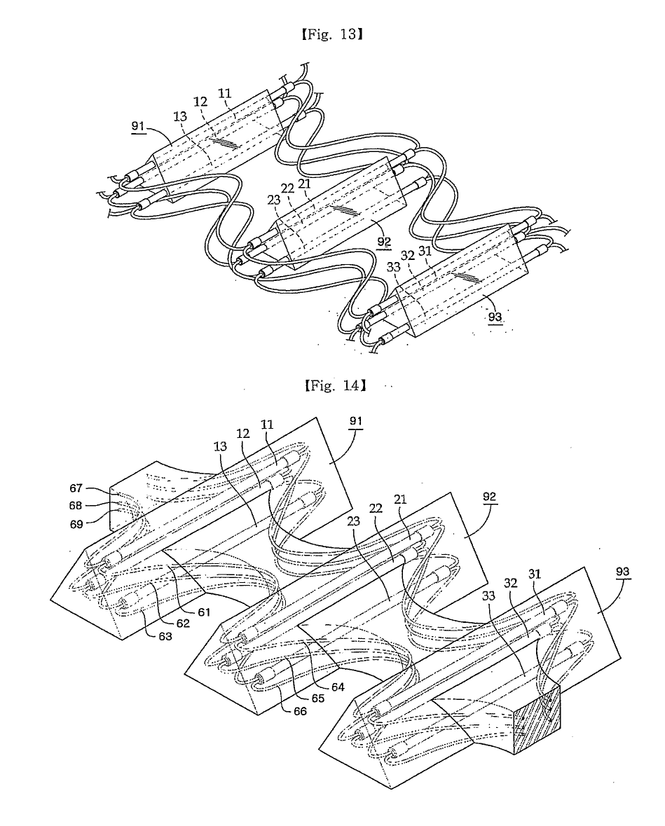

FIG. 11 is a perspective view showing a structure of an illumination apparatus comprising a plurality of EEFLs according to a fifth embodiment and FIG. 12 is an exploded perspective view illustrating a structure of the support members 41, 42 and the support plate 51 shown in FIG. 11. In FIGS. 11 and 12, the same elements as the embodiment shown in FIG. 6 are referred to with the same reference numerals and detailed descriptions thereof will be omitted.

The illumination apparatus according to the fifth embodiment comprises the first to third EEFL sets like the third embodiment. In the mean time, as shown in FIG. 12, the support member 41 comprises a main body 41-1 and a cover 41-2. Likewise, each of the other support members 42; 43, 44; 45, 46 comprises a main body and a cover. In addition, the main bodies of the support members 41, 42; 43, 44; 45, 46 comprise three protruding parts in FIG. 11. Specifically, as shown in FIG. 12, each of the support members 41, 42 is formed with three hollow protruding parts and hollow cylindrical sockets 81-1, 81-2, 81-3; 82-1, 82-2, 82-3 made of an electrically conductive material such as copper are provided to inner walls of the protruding parts, respectively. External electrodes (not shown) are formed on both ends of the EEFLs 11, 12, 13 and the parts having the electrodes formed thereon are inserted into the sockets 81-1, 81-2, 81-3; 82-1, 82-2, 82-3. In addition, silicon covers 81-5, 81-6, 81-7; 82-5, 82-6, 82-7 are further formed on the outer circumferences of the protruding parts of the support members 41, 42 having the sockets 81-1, 81-2, 81-3; 82-1, 82-2, 82-3 therein and the EEFLs 11, 12, 13 adjacent to the protruding parts. In the same manner, as shown in FIG. 11, the sockets are provided to the inner walls of the three protruding parts of the support members 43, 44; 45, 46 and the electrode parts of the EEFLs are inserted into the sockets. In addition, the cover made of silicon essentially and having a pre-determined length is further provided on the outer circumferences of the protruding parts of the support members 43, 44; 45, 46 having the sockets therein and the EEFLs 21, 22, 23; 31, 32, 33 adjacent to the protruding parts. As shown in FIG. 11, the other ends of the sockets are fixedly connected with the electric wires that extend outside through a side of the support member. The silicon cover is structured to cover the EEFL and the protruding part with a proper pressure and thus prevents the EEFL from being shaken in the socket and thus the short.

In addition, as shown in FIG. 12, the support plates 51-1, 51-2 extend from lower parts of the support members 41, 42 in a perpendicular relation. Both sides of the support plates 51-1, 51-2 are formed with connecting parts. A length regulating rod 52-1 is movably inserted into the two connecting parts formed on sides of the support plates 51-1, 51-2 and a length regulating rod 52-2 is movably inserted into the two connecting parts formed on the other sides of the support plates 51-1, 51-2. Likewise, the support plates 53-1, 53-2; 55-1, 55-2 extend from lower parts of the support members 43, 44; 45, 46 in a perpendicular relation, respectively. Both sides of the support plates 53-1, 53-2; 55-1, 55-2 are respectively formed with connecting parts. A length regulating rod 54-1; 56-1 is movably inserted into the two connecting parts formed on sides of the support plates 53-1, 53-2; 55-1, 55-2 and a length regulating rod 54-2; 56-2 is movably inserted into the two connecting parts formed on the other sides of the support plates 53-1, 53-2; 55-1, 55-2.

With the above structure, since the EEFL is inserted into the socket rather than the through-hole, the connection is easy and the stability is increased after the connection. In addition, since the electric wires are connected to the sockets rather than the EEFLs, even when the wires are disconnected from the socket, it is possible to easily perform a repair by replacing the socket only. Additionally, since the electric wires are connected to the socket and thus extended to the exterior through the support member, it is possible to prevent the entanglement of the wires and the short due to the entanglement.

Accordingly, since the width between the support members can be adjusted by regulating the length of the rod arbitrarily irrespective of the length of the EEFL, it is not required to differentiate the length of the support plate depending on the lengths of the EEFLs. In other words, this embodiment is advantageous to the mass production.

FIG. 13 is a perspective view of an illumination apparatus comprising a plurality of EEFLs according to a sixth embodiment of the invention. In FIG. 13, the elements performing the same functions as the embodiment in FIG. 6 are referred to with the same reference numerals as in FIG. 6 and detailed descriptions thereof will be omitted. In FIG. 13, all the EEFLs 11, 12, 13; 21, 22, 23; 31, 32, 33 are embedded in support bodies made of silicon 91, 92, 93 and having a triangle flask shape. Like this, when the support member is made into the solid support body, an exterior shock can be further endured. Accordingly, the structure shown in FIG. 13 is advantageous to an illumination apparatus wherein movements and shocks occur frequently.

FIG. 14 is a perspective view showing another structure of the illumination apparatus comprising a plurality of EEFLs according to a sixth embodiment of the invention. According to this embodiment, the EEFLs are completely embedded in the silicon support bodies 91, 92, 93. The electric wires penetrate the silicon support bodies to be exposed to the exterior and are connected with the other electric wires in the exterior of the silicon support bodies. The connected electric wires are covered with silicon. The connected electric wires may be covered with silicon after the electric wires are connected with each other, or each of the electric wires may be coated with silicon and then connected with the other silicon coated electric wires. Like this, when the electric wires and the EEFLs are completely embedded in the silicon, the illumination apparatus can normally operate for a long time without being affected by external environments such as exterior shock, moisture, water and the like.

While the invention has been shown and described with reference to certain preferred embodiments thereof, it will be understood by those skilled in the art that various changes in form and details may be made thereto without departing from the spirit and scope of the invention as defined by the appended claims.

1-2. (canceled)

3. An illumination apparatus comprising:
a plurality of external electrode fluorescent lamp (EEFL) sets, each set consisting of a plurality of EEFLs emitting a different color of light; and
a plurality of electric wires connecting the EEFLs to each other, each of which emitting a same color of light,
wherein the EEFLs and the EEFL sets are arranged in a same plane.

4. The illumination apparatus according to claim 3, wherein each of the EEFL sets consists of three EEFLs emitting red, green and blue lights, respectively.

5. An illumination apparatus comprising:
a plurality of external electrode fluorescent lamp (EEFL) sets, each set consisting of a plurality of EEFLs;
at least one pair of support members arranged to be opposite to each other so as to respectively support the EEFL set and being formed with through-holes into which both ends of the EEFLs are inserted; and
electric wires formed on a side of the EEFL and electrically connecting the EEFL.

6. An illumination apparatus comprising:
a plurality of external electrode fluorescent lamp (EEFL) sets, each set consisting of a plurality of EEFLs;
at least one pair of support members arranged to be opposite to each other so as to support the EEFL set and having a plurality of hollow protruding parts formed thereto;
sockets for inserting the EEFLs, each of sockets being provided to an inner wall of the protruding part; and
electric wires provided to a side of the socket and connecting the one EEFL to the other EEFL,
wherein the protruding parts formed to each of the pair of support members be provided at positions corresponding to each other, respectively, so that one end of each of the EEFLs constituting the EEFL set is inserted into the socket formed in the protruding part of the one of the support members and the other end of the EEFL is inserted into the socket formed in the protruding part of the other support member.

7. The illumination apparatus according to claim 5 or 6, wherein the EEFLs constituting the EEFL set emit different colors of lights, respectively.

8. The illumination apparatus according to claim 5 or 6, wherein each of the EEFL sets consists of three EEFLs emitting red, green and blue lights respectively.

9. The illumination apparatus according to claim 5 or 6, wherein a cover covering the EEFL and the protruding part is formed on outer circumferences of the protruding part having the socket formed therein and the EEFL adjacent to the protruding part.

10. The illumination apparatus according to claim 5 or 6, further comprising a support plate having a rectangular shape and formed between the pair of support members.

11. The illumination apparatus according to claim 5 or 6, further comprising support plates perpendicularly extending from each of lower parts of the pair of support members toward the other support member and having insert recesses, and an insert rod movably inserted between the insert recesses to adjust a width between the support plates.

12. The illumination apparatus according to claim 5 or 6, further comprising a clip for fixing the electric wires.

13. The illumination apparatus according to claim 5 or 6, further comprising a clip for fixing the electric wires, wherein the wire fixing clip separately fixes the electric wires.

14. The illumination apparatus according to claim 5 or 6, the apparatus being made of solid silicon except parts in which the through-holes of the support member are formed.

15. The illumination apparatus according to claim 5 or 6, further comprising silicon covering the electric wires.

16. The illumination apparatus according to claim 5 or 6, wherein the support member is made of at least one selected from silicon, acryl and plastics.

17. A belt-type illumination apparatus comprising:
a plurality of external electrode fluorescent lamps (EEFLs) arranged to be parallel with each other at a distance;
electrode connecting wires electrically connecting external electrodes formed on both ends of the EEFLs to each other;
insulating connectors covering both ends of the EEFLs; and
a connecting link connecting the wires and maintaining a distance between the wires to be constant.

18. The illumination apparatus according to claim 17, further comprising an insulating film covering the connectors on both ends of the EEFLs and the wires.
